(19) United States
(12) Patent Application Publication
(10) Pub. No.: US 2025/0264820 A1
(43) Pub. Date: Aug. 21, 2025

(54) TONER MANUFACTURING METHOD

(71) Applicant: CANON KABUSHIKI KAISHA, Tokyo (JP)

(72) Inventors: SATOSHI ARIMURA, Kanagawa (JP); KENTA KAMIKURA, Kanagawa (JP); TAKUHO SATO, Shizuoka (JP); MOTOYA FUKUSHIMA, Shizuoka (JP)

(21) Appl. No.: 19/053,249

(22) Filed: Feb. 13, 2025

(30) Foreign Application Priority Data
Feb. 16, 2024 (JP) 2024-021720

(51) Int. Cl. G03G 9/08

(52) U.S. Cl. CPC G03G 9/0806

(57) ABSTRACT

A toner manufacturing method including a particle-forming process including forming a resin particle while foam is generated in an aqueous medium, wherein the aqueous medium contains a fine bubble, and wherein the fine bubble has a number average particle size greater than or equal to 1.0×10¹ nm and less than or equal to 1.0×10⁵ nm and has a number concentration greater than or equal to 1.00×10⁵ bubbles/mL.

### BACKGROUND

### Technical Field

The present disclosure relates to a manufacturing method of toner for use in electrophotographic methods, electrostatic recording methods, and toner jet recording methods.

### Description of the Related Art

As toner manufacturing methods, suspension polymerization methods and emulsion polymerization aggregation methods, in which a mixture of a polymerizable monomer, a colorant, a release agent, and a crystalline component, such as a crystalline resin, is dispersed in an aqueous medium to obtain toner particles, are discussed. The wet process of manufacturing toner in the aqueous medium excels in developability and transferability due to its properties, such as the property of encapsulating the release agent and the crystalline resin and ease of shape control, compared to pulverization processes, which are dry manufacturing methods that do not use an aqueous medium.

However, the wet methods for manufacturing toner have the following disadvantages that need to be solved. For example, under wet conditions, foam may be generated during the polymerization reaction depending on stirring conditions and toner formulation. The foam comes into broad contact with gas-liquid interfaces of a reactor vessel wall and a stirring blade. After coming into broad contact with the reactor vessel wall and a stirrer, the foam melts due to heat or undergoes a chemical reaction and forms a hard scale. Furthermore, scale adhesion accumulates during continuous production, which causes disadvantages such as a failure to stir uniformly in the reaction vessel, temperature control failure caused by adhesion, and pipeline blockage. Cleaning to remove the adhesion from the apparatus requires effort and time and, furthermore, the reaction using the reactor vessel is forced to be suspended during cleaning, which causes disadvantages in productivity. Thus, suppressing the generation of foam is widely required.

Japanese Patent Application Laid-Open No. 2001-92184 discusses a manufacturing method designed to reduce scale adhesion by freely dispersing a dispersion stabilizer in a reaction system using a continuous polymerization method.

In Japanese Patent Application Laid-Open No. 2001-92184, the time the generated foam remains in the reactor vessel is reduced, which is expected to suppress scale adhesion to a certain extent. However, reducing the time cannot prevent foam generation completely, and the foam continues to cause scale formation. Thus, there is a demand for a method that can further reduce the amount of scale adhesion.

### SUMMARY

The present disclosure provides a toner manufacturing method capable of suppressing scale adhesion to a production apparatus, such as a reactor vessel wall or a stirring blade, and also reducing coarse particles that are out-of-specification toner particles.

According to an aspect of the present disclosure, a toner manufacturing method includes a particle-forming process including forming a resin particle while foam is generated in an aqueous medium, wherein the aqueous medium contains a fine bubble, and wherein the fine bubble has a number average particle size greater than or equal to 1.0×10¹ nm and less than or equal to 1.0×10⁵ nm and has a number concentration greater than or equal to 1.00×10⁵ bubbles/mL.

Further features of the present disclosure will become apparent from the following description of exemplary embodiments.

### DESCRIPTION OF THE EMBODIMENTS

In the present disclosure, unless otherwise specified, the phrases “greater than or equal to XX and less than or equal to YY” and “XX to YY” indicating a numerical range each refer to a numerical range including lower and upper limits that are endpoints. In cases where a numerical range is described in stages, the upper and lower limits of each range can be in any combination.

### Feature of the Present Disclosure

The toner manufacturing method according to the present disclosure includes a particle-forming process of forming a resin particle while foam is generated in an aqueous medium, wherein the aqueous medium contains a fine bubble, and wherein the fine bubble has a number average particle size greater than or equal to 1.0×10¹ nm and less than or equal to 1.0×10⁵ nm and has a number concentration greater than or equal to 1.00×10⁵ bubbles/mL. The foregoing toner manufacturing method enables manufacturing of toner particles while suppressing scale adhesion to a production apparatus, such as a reactor vessel wall or a stirring blade.

The present inventors consider that the effect of the present disclosure is achieved due to the following reason.

During the particle-forming process, the number average particle size of the fine bubbles contained in the aqueous medium is greater than or equal to 1.0×10¹ nm and less than or equal to 1.0×10⁵ nm, and the number concentration of fine bubbles contained in the aqueous medium is 1.00×10⁵ bubbles/mL or higher. Thus, the foam generated by a polymerization reaction or stirring is generated with the interfaces of fine bubbles serving as nuclei, which may be energetically advantageous. Furthermore, since there are countless fine bubbles that can serve as nuclei in the aqueous medium, the diameter of each bubble of foam generated by a polymerization reaction or stirring is considered to decrease due to the following reason. In general, the surface energy of the generated foam is expressed by the following formula (A):

$$B = 4 a π {r}^{2} - 4 / 3 b π {r}^{3} , \qquad formula ( A )$$

where B is the surface energy of the foam, r is the radius of the foam, and a and b are coefficients that vary with the medium.

This formula (A) indicates that the smaller the foam radius, the more unstable the surface energy of the foam becomes. Specifically, with the fine bubbles serving as nuclei, the radius of the foam generated by a polymerization reaction or stirring becomes smaller, and the surface energy of the foam becomes unstable. As the surface energy of the foam becomes unstable, the foam state can no longer be maintained, which leads to prompt bubble rupture. This is considered to lead to suppression of scale adhesion.

On the other hand, in cases where there are no fine bubbles during the particle-forming process, there are no nuclei such as fine bubbles during the generation of foam by a polymerization reaction or stirring. Thus, the generated foam has a large foam radius, which is energetically stable, and remains for an extended period. This is considered to lead to worsening of scale adhesion.

### [Main Components Related to the Present Disclosure]

The number average particle size of the fine bubbles is greater than or equal to 1.0×10¹ nm and less than or equal to 1.0×10⁵ nm, preferably greater than or equal to 1.0×10¹ nm and less than or equal to 1.0×10³ nm. By satisfying the foregoing range, fine bubbles can remain in the aqueous medium for an extended period, whereby the effect of the present disclosure is achieved. Further, fine bubbles in the range greater than or equal to 1.0×10¹ nm and less than or equal to 1.0×10³ nm are particularly referred to as ultra-fine bubbles. One of the characteristics of ultra-fine bubbles is that ultra-fine bubbles are less likely to disappear and, furthermore, can remain for an extended period. Thus, the effect of the present disclosure is more easily achieved.

There is a method for controlling the particle size of the fine bubbles through membrane separation. Specifically, the fine bubbles are passed through a plurality of filtration filters with desired pores to separate and classify the fine bubbles with a desired radius.

It should be noted that the number average particle size of fine bubbles in the present disclosure refers to a numerical value obtained through measurement of an aqueous medium used as a material. In cases where an aqueous medium containing fine bubbles having a different number average particle size is added during manufacturing, it is calculated based on a theoretical value, taking the number and number average particle size of the added fine bubbles into account, during the particle-forming process.

The number concentration of the fine bubbles is greater than or equal to 1.00×10⁵ bubbles/mL, preferably greater than or equal to 1.00×10⁶ bubbles/mL. A higher number concentration of the fine bubbles indicates a greater number of fine bubbles that can serve as nuclei, which makes it easier to achieve the effect of the present disclosure.

As a method for controlling the number concentration of fine bubbles per 1 mL, the fine bubbles may be passed through the filtration filters using membrane separation to concentrate fine bubbles and increase the number of fine bubbles. Further, the number concentration can also be increased by circulation through a publicly-known fine bubble generating apparatus. On the other hand, the number concentration can be decreased by adding an aqueous medium for dilution.

It should be noted that the number concentration of fine bubbles in the present disclosure refers to a numerical value obtained through measurement of an aqueous medium used as a material. In cases where an aqueous medium is added during manufacturing, it is calculated based on a theoretical value, taking the added aqueous medium into account, during the particle-forming process. In cases where fine bubbles with a different number concentration (bubbles/mL) are added, it is similarly calculated based on a theoretical value during the particle-forming process.

In cases where the particle-forming process is a process of forming resin particles by polymerizing a polymerizable monomer in droplet particles dispersed in an aqueous medium using a polymerization initiator, foam caused by gas produced as a result of cleavage of the polymerization initiator is considered to be dominant. The foam caused by the foregoing factor is generated in greater amounts and involves a higher heat quantity during early stages of polymerization initiator addition. In this case, if fine bubbles that can serve as nuclei are abundantly present, the generated foam has a small radius, and the foam with a small radius becomes energetically unstable due to the generated heat and ruptures promptly.

On the other hand, in cases where the particle-forming process is a process performed while the aqueous medium is stirred, foam generated as stirring is performed is considered to be dominant. The foam caused by the foregoing factor in the present disclosure is continuously generated by stirring. In this case, if fine bubbles that can serve as nuclei are abundantly present, the generated foam has a small radius. The foam with a small radius becomes energetically unstable and ruptures continuously. Particularly during a temperature rise in a process that requires reactions in the manufacturing process, more energy is received from external sources, which further promotes bubble rupture.

The following inequality (1) is preferably satisfied:

$$T < 500 \times Q / V + 30 , \qquad inequality ( 1 )$$

where Q (L/min) represents the discharge rate of the stirrer in the particle-forming process, V (L) represents the total amount of the aqueous medium, and T (° C.) represents the temperature of the aqueous medium.

Inequality (1) represents the relationship between a reaction temperature and the discharge rate. Specifically, a higher discharge rate of the stirring blade is preferable at higher temperatures during the particle-forming process. This indicates the frequency of contact between toner particle precursors and fine bubbles. While the fine bubbles become unstable at higher reaction temperatures during the particle-forming process, the frequency of contact between toner particles and fine bubbles can be increased by increasing the discharge rate of the stirring blade. As the frequency of contact between toner particles and fine bubbles increases, coalescence due to toner particle collisions is suppressed, which results in an improved and narrower particle size distribution of the toner particles.

A discharge rate Q (m³/sec) herein is obtained from the following formula:

$$Q = Nq \times n \times {d}^{3} ,$$

where Nq is a discharge coefficient, n is the number of rotations (r/sec) of the stirring blade per unit time, and d is a blade diameter (m) of the stirring blade.

The discharge coefficient Nq herein is a unique specific value that varies for each stirring blade and is determined based on the shape of the stirring blade, the shape of a rotor, and a screen diameter.

Further, the temperature T (° C.) of the aqueous medium is a temperature of the aqueous medium that is directly measured immediately after the aqueous medium reaches a target temperature.

The temperature T (° C.) of the aqueous medium is preferably 20° C.≤T≤80° C., more preferably 30° C.≤T≤75° C. This is preferable because fine bubbles can stably remain in the aqueous medium at or below the upper limit temperature. Further, being at or above the lower limit temperature is preferable from the point of view of reactions during toner particle formation.

It is preferable to satisfy the following inequality (2):

$$A / B > 1. \times 1 {0}^{3} , \qquad inequality ( 2 )$$

where A represents the number concentration (bubbles/mL) of the fine bubbles, and B represents the number average particle size (nm) of the fine bubbles.

Inequality (2) represents the relationship between the number concentration of fine bubbles and the number average particle size of fine bubbles. Specifically, a smaller number average particle size of fine bubbles is preferable at a lower number concentration of fine bubbles. This indicates the state of the bubbles that serve as nuclei. As the number concentration of fine bubbles decreases, nuclei for foam also decrease, and as the number average particle size of fine bubbles decreases, the contact area of foam generated during the particle-forming process decreases, which enables foam radius reduction. As the foam radius of the foam generated during particle-forming process decreases, the surface energy of the foam becomes more unstable, which leads to prompt bubble rupture and a reduction in coarse particles that are out-of-specification toner particles caused by the foam during the particle-forming process. Further, as the number average particle size of fine bubbles increases, the foam radius tends to increase, and as the number concentration of fine bubbles increases, nuclei for foam generated during the particle-forming process also increase, which eventually enables the reduction of the radius of the foam generated during the particle-forming process. This leads to a reduction in coarse particles that are out-of-specification toner particles caused by the foam. Specifically, the number concentration of fine bubbles and the number average particle size of fine bubbles are mutually related, and satisfying inequality (2) leads to a reduction in coarse particles that are out-of-specification toner particles.

Further, the particle-forming process is preferably a process of forming resin particles by polymerizing a polymerizable monomer in droplet particles dispersed in an aqueous medium using a polymerization initiator and preferably includes a process of increasing a temperature after the polymerization initiator is added, and the temperature is preferably increased at a rate of 0.3° C./min or less in the temperature-increasing process. By satisfying the foregoing range, gas is produced more gradually as a result of cleavage of the polymerization initiator, which leads to increased foam generation with fine bubbles serving as nuclei.

Thus, the foam radius is further reduced, and the surface energy of the foam becomes more unstable, which leads to prompt bubble rupture and a further reduction in coarse particles that are out-of-specification toner particles caused by the foam during the particle-forming process.

Fine bubbles used in toner particle manufacturing in the present disclosure are not specifically limited, and any fine bubbles produced by conventional, publicly-known manufacturing methods may be used. Specific fine bubble manufacturing methods will be described below.

An example of fine bubble manufacturing methods is a swirling fluid flow based on the principle of gas-phase dispersion by fluid shear. In this method, liquid flows into a cylindrical container at a high speed to generate a high-speed swirling flow in the container, and gas is drawn in using the negative pressure generated at the central part of the high-speed swirling flow, resulting in the formation of a gas column at the central part of the container. The gas column is fragmented by an intense shear flow generated at a downstream outlet, and fine bubbles are generated.

Other fine bubble manufacturing methods based on the principle of gas-phase dispersion by fluid shear include static mixer methods, mechanical shear methods, micropore methods, and fluid oscillation methods.

Further, fine bubble manufacturing methods based on the principle of changes in gas solubility in liquids include pressure dissolution methods and heating precipitation methods. Fine bubble manufacturing methods based on the principle of cavitation include ejector methods, Venturi methods, and ultrasonic wave methods. Fine bubble manufacturing methods based on the principle of phase transitions in dispersed phases include mixed vapor condensation methods. Fine bubble manufacturing methods based on the principle of chemical changes in liquid phases include electrolysis methods.

### [Toner Manufacturing Method]

A feature of the toner manufacturing method is that it includes the particle-forming process of forming resin particles while foam is generated in an aqueous medium containing fine bubbles. Specifically, publicly-known methods of manufacturing toner particles in an aqueous medium, such as suspension polymerization methods, dissolution suspension methods, and emulsion aggregation methods, may be used. It should be noted that the particle-forming process in the present disclosure includes all processes during the state in which the precursors of toner resin microparticles or some of them are dispersed in the aqueous medium.

Each process of a toner particle manufacturing method using a suspension polymerization method will be described below as an example.

The suspension polymerization method refers to a method of manufacturing toner particles by forming polymerizable monomer composition particles containing a polymerizable monomer and a colorant in an aqueous medium and polymerizing the polymerizable monomer contained in the polymerizable monomer composition particles.

### (Polymerizable Monomer Composition Preparation Process)

A polymerizable monomer composition containing a polymerizable monomer and a colorant is prepared. The colorant may be pre-dispersed in the polymerizable monomer using a stirred media mill and thereafter mixed with other compositions, or may be dispersed after all compositions are mixed.

### (Granulation Process)

The polymerizable monomer composition is added to an aqueous medium containing an inorganic dispersion stabilizer and is dispersed to form granules, and a polymerizable monomer composition dispersion liquid is obtained. The granulation process can be performed in, for example, a vertical stirring tank equipped with a high-shear stirrer. The high-shear stirrer is not specifically limited, and any commercially-available high-shear stirrer may be used, such as a High-shear Mixer (manufactured by IKA), T.K. HOMO MIXER (manufactured by Tokushu Kika Kogyo Co., Ltd.), T.K. FILMIX (manufactured by Tokushu Kika Kogyo Co., Ltd.), or CLEARMIX (manufactured by M Technique Co., Ltd.).

Examples of inorganic dispersion stabilizers include carbonates such as barium carbonate, calcium carbonate, and magnesium carbonate, metal phosphates such as aluminum phosphate, magnesium phosphate, calcium phosphate, barium phosphate, and zinc phosphate, sulfates such as barium sulfate and calcium sulfate, and metal hydroxides such as calcium hydroxide, aluminum hydroxide, magnesium hydroxide, and iron (II) hydroxide. These may be used alone or in combination of two or more types. By being present as inorganic microparticles with low water solubility in the aqueous medium, they function as dispersion stabilizers.

### (Reaction Process)

The polymerizable monomer in the polymerizable monomer composition dispersion liquid obtained as described above is polymerized to obtain a toner particle dispersion liquid. In the reaction process in the present disclosure, a general stirring tank with adjustable temperature may be used. The polymerization is performed at a polymerization temperature of 40° C. or higher, typically 50° C. to 90° C. The polymerization temperature may be maintained constant throughout, or may be increased in the latter stage of the polymerization process in order to achieve a desired molecular weight distribution.

The stirring blade used for stirring may be any stirring blade capable of suspending the polymerizable monomer composition dispersion liquid without allowing it to settle and also capable of maintaining the temperature constant in the tank. Examples of stirring blades or stirring units include general stirring blades, such as paddle blades, inclined paddle blades, three swept-back blades, propeller blades, disk turbine blades, helical ribbon blades, and anchor blades, “Fullzone” (manufactured by Shinko Pantec Co., Ltd.), “TWINSTIR” (manufactured by Shinko Pantec Co., Ltd.), “MAXBLEND” (manufactured by Sumitomo Heavy Industries, Ltd.), “Super Mix” (manufactured by Satake Chemical Equipment MFG., Ltd.), and “Hi-F Mixer” (manufactured by Soken Chemical & Engineering Co., Ltd.).

### (Organic Volatile Component Removal Process)

Volatile impurities such as unreacted polymerizable monomers and byproducts present in the toner particle dispersion liquid obtained through the reaction process can be removed. The organic volatile component removal process can be performed under normal pressure or reduced pressure, and various removal methods capable of removing organic volatile components to a desired concentration may be used.

### (Cleaning Process, Solid-Liquid Separation Process)

The toner particle dispersion liquid is treated with acid or alkali to remove the dispersion stabilizer attached to the toner particle surface. Thereafter, polymer particles are separated from the liquid phase by a general solid-liquid separation method. In order to completely remove the acid or alkali and dispersion stabilizer components dissolved therein, the toner particles are cleaned again with water. After the cleaning process is repeated several times to clean the toner particles sufficiently, solid-liquid separation is performed again to obtain wet toner particles.

### (Drying Process)

The obtained wet toner particles are dried to remove the water and aqueous medium contained therein. Various drying methods used in general drying processes, such as vacuum drying, fluidized bed drying, and air flow drying, may be used.

### (Classification Process)

In order to achieve a required particle size distribution, classification is performed using an air classifier after drying to obtain desired toner particles.

### (Additive Process)

In order to impart various properties to the toner particles, external additives and the toner particles are mixed to obtain toner.

[Components that Constitute Toner Particles]

The components that constitute the toner particles will be described in further detail below.

### <Polymerizable Monomer>

Examples of polymerizable monomers that are preferably used in the toner in the present disclosure and are binder resin components described below include vinyl-based polymerizable monomers capable of radical polymerization. Monofunctional or polyfunctional vinyl-based polymerizable monomers may be used. Examples of monofunctional polymerizable monomers are as follows.

Styrene, styrene derivatives such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene, acrylic-based monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate, methacrylate-based polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate, vinyl esters such as methylene aliphatic monocarboxylic acid ester, vinyl acetate, vinyl propionate, vinyl butyrate, vinyl benzoate, and vinyl formate, vinyl ethers such as vinylmethyl ether, vinylethyl ether, and vinylisobutyl ether, and vinyl ketones such as vinylmethyl ketone, vinylhexyl ketone, and vinylisopropyl ketone.

### <Colorants>

Examples of colorants preferably used in the present disclosure include the following organic pigments or dyes and inorganic pigments.

Examples of organic pigments or organic dyes that may be used as cyan-based colorants include copper phthalocyanine compounds and derivatives thereof, anthraquinone compounds, and basic dye lake compounds.

Specific examples include C.I. Pigment Blue 1, C.I. Pigment Blue 7, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 60, C.I. Pigment Blue 62, and C.I. Pigment Blue 66.

Examples of organic pigments or organic dyes that may be used as magenta-based colorants include the following compounds.

Condensed azo compounds, diketopyrrolopyrrole compounds, anthraquinone, quinacridone compounds, basic dye lake compounds, naphthol compounds, benzimidazolone compounds, thioindigo compounds, and perylene compounds.

Specific examples include C.I. Pigment Red 2, C.I. Pigment Red 3, C.I. Pigment Red 5, C.I. Pigment Red 6, C.I. Pigment Red 7, C.I. Pigment Violet 19, C.I. Pigment Red 23, C.I. Pigment Red 48:2, C.I. Pigment Red 48:3, C.I. Pigment Red 48:4, C.I. Pigment Red 57:1, C.I. Pigment Red 81:1, C.I. Pigment Red 122, C.I. Pigment Red 144, C.I. Pigment Red 146, C.I. Pigment Red 150, C.I. Pigment Red 166, C.I. Pigment Red 169, C.I. Pigment Red 177, C.I. Pigment Red 184, C.I. Pigment Red 185, C.I. Pigment Red 202, C.I. Pigment Red 206, C.I. Pigment Red 220, C.I. Pigment Red 221, and C.I. Pigment Red 254.

Examples of organic pigments or organic dyes that may be used as yellow-based colorants include compounds such as condensed azo compounds, isoindolinone compounds, anthraquinone compounds, azo metal complexes, methine compounds, and allylamide compounds.

Specific examples include C.I. Pigment Yellow 12, C.I. Pigment Yellow 13, C.I. Pigment Yellow 14, C.I. Pigment Yellow 15, C.I. Pigment Yellow 17, C.I. Pigment Yellow 62, C.I. Pigment Yellow 74, C.I. Pigment Yellow 83, C.I. Pigment Yellow 93, C.I. Pigment Yellow 94, C.I. Pigment Yellow 95, C.I. Pigment Yellow 97, C.I. Pigment Yellow 109, C.I. Pigment Yellow 110, C.I. Pigment Yellow 111, C.I. Pigment Yellow 120, C.I. Pigment Yellow 127, C.I. Pigment Yellow 128, C.I. Pigment Yellow 129, C.I. Pigment Yellow 147, C.I. Pigment Yellow 151, C.I. Pigment Yellow 154, C.I. Pigment Yellow 155, C.I. Pigment Yellow 168, C.I. Pigment Yellow 174, C.I. Pigment Yellow 175, C.I. Pigment Yellow 176, C.I. Pigment Yellow 180, C.I. Pigment Yellow 181, C.I. Pigment Yellow 191, and C.I. Pigment Yellow 194.

Black colorants that may be used are carbon black and colorants adjusted to black using the yellow-based/magenta-based/cyan-based colorants.

The foregoing colorants may be used either alone, in mixtures, or even in the form of solid solutions. Colorants used in the toner in the present disclosure are selected based on hue angle, color saturation, lightness value, light fastness, overhead projector (OHP) transparency, and dispersibility in toner.

The amount of colorants added and used is preferably 1 part by mass or more and 20 parts by mass or less, based on 100 parts by mass of a binder resin.

Magnetic materials can be contained as colorants. Examples of magnetic materials include magnetic iron oxides such as magnetite, maghemite, and ferrite, metals such as iron, cobalt, and nickel, or alloys and mixtures of these metals with metals such as aluminum, copper, magnesium, tin, zinc, beryllium, calcium, manganese, selenium, titanium, tungsten, and vanadium.

The amount of magnetic materials contained or added is preferably 20 parts by mass or more and 100 parts by mass or less, more preferably 25 parts by mass or more and 90 parts by mass or less, based on 100 parts by mass of the binder resin or the polymerizable monomer that can form a binder resin.

### <Release Agents>

Waxes that are in a solid state at room temperature are preferably used as release agents in the present disclosure in terms of toner resistance to blocking, multi-sheet durability, low-temperature fixability, and offset resistance.

Examples of waxes include paraffin waxes, polyolefin waxes, microcrystalline waxes, polymethylene waxes such as Fischer-Tropsch waxes, amide waxes, higher fatty acids, long-chain alcohols, ester waxes, graft compounds thereof, and block compounds thereof.

### <Charge Control Agents>

Toner manufactured by the present disclosure may contain charge control agents. Publicly-known charge control agents may be used. Examples of charge control agents that control toner to exhibit negative chargeability include organometallic compounds and chelate compounds, which are effective, monoazo-based dye metal compounds, acetylacetonate metal compounds, aromatic hydroxycarboxylic acids, aromatic monocarboxylic and polycarboxylic acids and metal salts thereof, anhydrides, esters, and phenol derivatives such as bisphenols. Examples further include urea derivative, metal-containing salicylic acid-based compounds, calixarenes, silicon compounds, styrene-acrylic acid copolymers, styrene-methacrylic acid copolymers, styrene-acrylic-sulfonic acid copolymers, and non-metal carboxylic acid-based compounds.

Examples of charge control agents that control toner to exhibit positive chargeability include modified products of nigrosin and fatty acid metal salts, quaternary ammonium salts such as tributylbenzylammonium-1-hydroxy-4-naphthosulfonate and tetrabutylammonium tetrafluoroborate, onium salts such as phosphonium salts and lake pigments thereof, triphenylmethane dyes and lake pigments thereof (lake-forming agents are phosphotungstic acid, phosphomolybdic acid, phosphotungstomolybdic acid, tannic acid, lauric acid, gallic acid, ferricyanide, or ferrocyanide), and metal salts of higher fatty acids.

The amount of charge control agents used is preferably 0.01 parts by mass or more and 20 parts by mass or less, more preferably 0.5 parts by mass or more and 10 parts by mass or less, based on 100 parts by mass of the polymerizable monomer.

### <Polymerization Initiators>

Various polymerization initiators, such as peroxide-based polymerization initiators and azo-based polymerization initiators, can be used in the present disclosure.

Examples of organic peroxide-based polymerization initiators include peroxy ester, peroxy dicarbonate, dialkyl peroxide, peroxy ketal, ketone peroxide, hydroperoxide, and diacylperoxide.

Specific examples of organic peroxide-based polymerization initiators include peroxy esters such as t-butylperoxy acetate, t-butyl peroxypivalate, t-butylperoxy isobutyrate, t-hexylperoxy acetate, t-hexylperoxy pivalate, t-hexylperoxy isobutyrate, t-butylperoxy isopropyl monocarbonate, and t-butylperoxy 2-ethylhexyl monocarbonate, diacyl peroxides such as benzoyl peroxide, peroxydicarbonates such as diisopropyl peroxydicarbonate, peroxy ketals such as 1,1-di-t-hexylperoxy cyclohexane, dialkyl peroxides such as di-t-butylperoxide, and t-butyl peroxy aryl monocarbonate.

Examples of inorganic peroxide-based polymerization initiators include persulfates and hydrogen peroxide.

Further, examples of azo-based polymerization initiators include 2,2′-azobis-(2,4-dimethylvaleronitrile), 2,2′-azobisisobutyronitrile, 1,1′-azobis (cyclohexane-1-carbonitrile), 2,2′-azobis-4-methoxy-2,4-dimethylvaleronitrile, azobisisobutyronitrile, and dimethyl-2,2′-azobis (2-methylpropionate).

In the present disclosure, organic peroxide-based polymerization initiators, such as t-butyl peroxypivalate, are suitably used in terms of polymerization efficiency.

Two or more types of the polymerization initiators may be used simultaneously as necessary.

The amount of polymerization initiators used is preferably 0.10 parts by mass or more and 20.0 parts by mass or less, based on 100.0 parts by mass of the polymerizable monomer.

### <Crosslinking Agents>

Various crosslinking agents may be used in the present disclosure. Examples of crosslinking agents include divinylbenzene, 4,4′-divinylbiphenyl, hexanediol diacrylate, ethylene glycol diacrylate, ethylene glycol dimethacrylate, diethylene glycol diacrylate, diethylene glycol dimethacrylate, glycidyl acrylate, glycidyl methacrylate, trimethylolpropane triacrylate, trimethylolpropane trimethacrylate.

### <Binder Resins>

Binder resins used in the present disclosure are not specifically limited and can be selected from publicly-known binder resins as appropriate. Examples include homopolymers, or copolymers, of styrenes such as styrene and chlorostyrene, monoolefins such as ethylene, propylene, butylene, and isoprene, vinyl esters such as vinyl acetate, vinyl propionate, vinyl benzoate, and vinyl butyrate, α-methylene aliphatic monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate, vinyl ethers such as vinylmethyl ether, vinylethyl ether, and vinylbutyl ether, vinyl ketones such as vinylmethyl ketone, vinylhexyl ketone, and vinylisopropenyl ketone.

Examples of polymers of styrene or derivatives thereof include polystyrene, poly (p-chlorostyrene), and polyvinyl toluene. Examples of styrene-based copolymers include styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-α-chloromethyl methacrylate copolymers, styrene-acrylonitrile copolymers, styrene-vinylmethyl ketone copolymers, styrene-butadiene copolymers, styrene-isoprene copolymers, styrene-acrylonitrile-indene copolymers, styrene-maleic acid copolymers, and styrene-maleic acid ester copolymers.

Examples of particularly representative binder resins include polystyrene resins, polyester resins, styrene-alkyl acrylic acid copolymers, styrene-alkyl methacrylic acid copolymers, styrene-acrylonitrile copolymers, styrene-butadiene copolymers, styrene-maleic anhydride copolymers, polyethylene resins, and polypropylene resins. These may be used alone or in combination with two or more types.

### <External Additives>

External additives may be added to the toner of the present disclosure as necessary. Examples include charging adjuvants, conductivity imparting agents, fluidity imparting agents, caking inhibitors, release agents during heat roller fixing, lubricants, and fine resin particles or fine inorganic particles that function as abrasives.

Examples of lubricants include polyfluoroethylene powder and polyvinylidene fluoride powder. Examples of abrasives include cerium oxide powder, silicon carbide powder, and strontium titanate powder.

### [Physical Property Measurement Methods]

Next, methods for measuring various physical properties including characteristics that are evaluation items in examples will be described below.

### <Methods for Measuring Weight Average Particle Size (D4), Number Average Particle Size (D1), and Particle Size Distributions (D4/D1) of Toner Particles>

The weight average particle size (D4) and the number average particle size (D1) of toner are calculated as described below. A precision particle size distribution measuring apparatus “Coulter Counter Multisizer 3®” (manufactured by Beckman Coulter, Inc.) including a 100-μm aperture tube and using an aperture impedance method is used as a measuring apparatus. Measurement conditions are set and measurement data is analyzed using included dedicated software “Beckman Coulter Multisizer 3 Version 3.51” (manufactured by Beckman Coulter, Inc.). It should be noted that the measurement is performed using a total of 25000 effective measuring channels.

An aqueous electrolytic solution prepared by dissolving special-grade sodium chloride in deionized water and adjusting the concentration to approximately 1 mass %, such as “ISOTON II” (manufactured by Beckman Coulter, Inc.), can be used in measurements.

Prior to measurements and analysis, the dedicated software is configured as follows.

On a “change standard measurement method (SOMME)” screen of the dedicated software, the total count of a control mode is set to 50000 particles, the number of measurements is set to 1, and a Kd value is set to a value obtained using “standard particles 10.0 μm” (manufactured by Beckman Coulter, Inc.). By pressing a “threshold/noise level measurement button”, a threshold and a noise level are automatically set. Further, the current is set to 1600 μA, the gain is set to 2, the electrolytic solution is set to ISOTON II, and “flush aperture tube after measurement” is checked.

On a “pulse-to-particle size conversion settings” screen of the dedicated software, the bin interval is set to logarithmic particle size, the particle size bin is set to 256 particle size bins, and the particle size range is set to 2 μm to 60 μm.

A specific measurement method is as follows.

(1) Approximately 200 ml of the electrolytic solution is placed into a 250-ml round-bottom glass beaker dedicated to the Multisizer 3, the beaker is placed on a sample stand, and a stirrer rod is rotated counterclockwise at 24 rotations per second. Next, dirt and bubbles in the aperture tube are removed using the “flush aperture” function of the dedicated software.
(2) Approximately 30 ml of the electrolytic solution is placed into a 100-ml flat-bottom glass beaker. Approximately 0.3 ml of a diluted solution of “Contaminon N” (10 mass % aqueous solution of a pH-7 neutral detergent containing nonionic surfactants, anionic surfactants, and organic builders and designed for cleaning precision measurement instruments, manufactured by Wako Pure Chemical Industries, Ltd.) as a dispersant diluted approximately threefold by mass with deionized water is added to the beaker.
(3) Two oscillators with an oscillation frequency of 50 kHz are incorporated with a 180-degree phase shift, and an ultrasonic disperser “Ultrasonic Dispersion System Tetra 150” (manufactured by NIKKAKI BIOS CO., LTD) with an electrical output of 120 W is prepared. Approximately 3.31 of deionized water is placed into a water tank of the ultrasonic disperser, and approximately 2 ml of Contaminon N is added to the water tank.
(4) The beaker in (2) is placed in a beaker fixing hole of the ultrasonic disperser, and the ultrasonic disperser is turned on. Then, the height position of the beaker is adjusted to maximize the resonant state of the liquid surface of the electrolytic solution in the beaker.
(5) While the electrolytic solution in the beaker in (4) is irradiated with ultrasonic wave, approximately 10 mg of toner is added in small amounts to the electrolytic solution and dispersed. Then, the ultrasonic dispersion process is continued for 60 seconds. It should be noted that during ultrasonic dispersion, the water temperature in the water tank is adjusted, as appropriate, to 10° C. or higher and 40° C. or lower.
(6) The aqueous electrolytic solution in (5) in which the toner is dispersed is dripped into the round-bottom beaker in (1) placed in the sample stand using a pipette, and the measurement concentration is adjusted to approximately 5%. Then, a measurement is performed until the number of measurement particles reaches 50000.
(7) A measurement data analysis is performed using the dedicated software included with the apparatus, and the weight average particle size (D4) and the number average particle size (D1) are calculated. It should be noted that the weight average particle size (D4) corresponds to an “average size” on an “analysis/volume statistical value (arithmetic mean)” screen in cases where graph/volume % is set using the dedicated software, and the number average particle size (D1) corresponds to an “average size” on an “analysis/number statistical value (arithmetic mean)” screen in cases where graph/number % is set using the dedicated software. Further, D4/D1 is defined as the particle size distribution.

### <Coarse Particle Content Measurement Methods>

A slurry solution with a toner particle solid content ratio of 20% is prepared in an amount of 500 g.

The slurry solution is passed through a mesh NXX7 (NBC Meshtec Inc.) with a pore size of 200 u, residual toner particles on the filter are sufficiently dried, and then the mass (g) is measured as the amount of coarse particles.

### <Number Average Particle Size and Number Concentration of Fine Bubbles>

The number average particle size and the number concentration of fine bubbles are measured as described below using a particle size measuring apparatus ViewSizer 3000 (manufactured by HORIBA, Ltd.) utilizing a particle tracking method.

As a sample, an aqueous medium containing fine bubbles is prepared.

A stirrer bar and a dedicated jig included with the apparatus are set into a quartz cell (High Precision Cell manufactured by Hellma Analytic, 10×10 mm), 2 ml of the measurement sample is poured into the cell, and the cell is set into a cell holder of the apparatus.

Nano tracking analysis is activated from an application included with the apparatus, and measurements are performed using the following settings:
Target temperature: 22,
Number of videos: 30,
Frame per second: 30,
Exposure: 18,
Gain: 24,
Stirring time: 5,
Video length: 300, and
Laser power B: 70,
   G: 12, and
   R: 8.

A numerical value of average size (nm) on a displayed measurement result screen displayed after the measurements are completed is used as the number average particle size of fine bubbles, and a numerical value of particle concentration (particles/mL) on the displayed screen is used as the number concentration of fine bubbles.

During the measurements, stirring is turned on in a streaming mode, and whether the contours of fine bubbles on an image displayed on a display are clear is checked, and in a state where stirring is off, whether the overlap between the fine bubbles on the image is minimal is checked. In cases where the contours are unclear, focus adjustment is performed using a focus function. Further, in cases where the overlap between the fine bubbles is significant, the sample is diluted. In cases where the sample is diluted, a value calculated by multiplying the obtained value of particle concentration by a dilution factor is used as the number concentration of fine bubbles.

### EXAMPLES

The present disclosure will be described in further detail below with reference to examples and comparative examples. However, the invention is not in any way restricted by the descriptions. Unless otherwise specified, the term “part” used in the examples is based on mass.

### <Examples of Production of Deionized Water Containing Fine Bubbles (Production of FB Deionized Water)>

### (Production of FB Deionized Water 1)

Deionized water was prepared, and the deionized water was passed through a fine bubble generating apparatus UP0290M 100 V motor type (manufactured by Shibata Co., Ltd.), whereby FB deionized water 1 containing fine bubbles was prepared. The number average particle size and the number concentration of the prepared fine bubbles were respectively 1.5×10² nm and 1.70×10⁶ bubbles/mL.

### (Production of FB Deionized Water 2)

Air ultra-fine bubble (nanobubble) water (NANOX Co., Ltd.) was diluted with deionized water at a ratio of 5000:1, whereby FB deionized water 2 containing fine bubbles was prepared. The number average particle size and the number concentration of the prepared fine bubbles were respectively 5.5×10¹ nm and 1.68×10⁶ bubbles/mL.

### (Production of FB Deionized Water 3)

Deionized water was prepared, and the deionized water was passed through a fine bubble generating apparatus UP0290M 100 V motor type (manufactured by Shibata Co., Ltd.), whereby deionized water containing fine bubbles was obtained. Further, the deionized water containing fine bubbles was passed through a 500-nm pore filter (manufactured by SPG Technology Co., Ltd.). After the deionized water was thoroughly passed, an aqueous medium before filtration was collected, whereby FB deionized water 3 containing fine bubbles was obtained. The number average particle size and the number concentration of the prepared fine bubbles were respectively 9.1×10² nm and 1.48×10⁶ bubbles/mL.

### (Production of FB Deionized Water 4)

Deionized water was prepared, a pipe provided with an SGP membrane filter (manufactured by SPG Technology Co., Ltd.) with a pore diameter of 10 μm was prepared in the deionized water, and air was introduced into the pipe at a pressure of 0.2 MPa, whereby FB deionized water 4 containing fine bubbles was prepared. The number average particle size and the number concentration of the prepared fine bubbles were respectively 8.5×10³ nm and 1.18×10⁵ bubbles/mL.

### (Production of FB Deionized Water 5)

Deionized water was prepared, a pipe provided with an SGP membrane filter (manufactured by SPG Technology Co., Ltd.) with a pore diameter of 100 μm was prepared in the deionized water, and air was introduced into the pipe at a pressure of 0.2 MPa, whereby FB deionized water 5 containing fine bubbles was prepared. The number average particle size and the number concentration of the prepared fine bubbles were respectively 9.2×10⁴ nm and 1.29×10⁵ bubbles/mL.

### (Production of FB Deionized Water 6)

The deionized water 1 containing fine bubbles was diluted with deionized water at a ratio of 15:1, whereby FB deionized water 6 containing fine bubbles was prepared. The number average particle size and the number concentration of the prepared fine bubbles were respectively 1.5×10² nm and 1.13× 10⁵ bubbles/mL.

### (Production of FB Deionized Water 7)

Deionized water was prepared, a pipe provided with an SGP membrane filter (manufactured by SPG Technology Co., Ltd.) with a pore diameter of 200 μm was prepared in the deionized water, and air was introduced into the pipe at a pressure of 0.2 MPa, whereby FB deionized water 7 containing fine bubbles was prepared. The number average particle size and the number concentration of the prepared fine bubbles were respectively 1.6×10⁵ nm and 1.29×10⁵ bubbles/mL.

### (Production of FB Deionized Water 8)

The deionized water 1 containing fine bubbles was diluted with deionized water at a ratio of 30:1, whereby FB deionized water 8 containing fine bubbles was prepared. The number average particle size and the number concentration of the prepared fine bubbles were respectively 1.5×10² nm and 5.67×10⁴ bubbles/mL.

### Preparation of Toner Particle 1 (First Example)

### (Preparation of Aqueous Medium Containing Dispersion Stabilizer)

In a container with a stirrer, a capacitor, a thermometer, and a nitrogen introduction tube, 100.00 parts of the deionized water 1 containing fine bubbles, 2.00 parts of sodium phosphate, and 0.90 parts of 10 mass % hydrochloric acid were added, and an aqueous solution of sodium phosphate was prepared and heated to 50° C. An aqueous solution of calcium chloride prepared by dissolving 1.2 parts of calcium chloride hexahydrate in 8.20 parts of the deionized water 1 containing fine bubbles was added to the container and stirred at a peripheral speed of 8000 rpm for 30 minutes using a T.K. homomixer (manufactured by Tokushu Kika Kogyo Co., Ltd.). Consequently, an aqueous medium containing (fine particles of) calcium phosphate was obtained as a dispersion stabilizer.

### (Preparation of Pigment Dispersion Composition)·

Polymerizable monomer: styrene 39.00 parts
Colorant: carbon black (manufactured by Orion Engineered Carbons, product name “Printex35”) 6.50 parts
Charge control agent (manufactured by ORIENT CHEMICAL INDUSTRIES CO., LTD.: BONTRON E-89) 0.25 parts

The foregoing materials were added to an Atritor disperser (manufactured by Mitsui Miike Kakoki Co., Ltd.) and dispersed at 220 rpm for 5 hours using zirconia particles with a diameter of 1.7 mm, and a pigment dispersion composition was obtained.

### (Polymerizable Monomer Composition Preparation Process)

The following materials were added to the same container and mixed and dispersed at 5000 rpm using a T.K. homomixer (manufactured by Tokushu Kika Kogyo Co., Ltd.), and a polymerizable monomer composition was obtained.
Pigment dispersion composition described above 45.00 parts
Polymerizable monomer: styrene 33.00 parts
Polymerizable monomer: n-butyl acrylate 28.00 parts
Polarity resin 10.00 parts
   (saturated polyester resin obtained through a condensation polymerization reaction of propylene oxide 2-mole adduct of bisphenol A with terephthalic acid and isophthalic acid, with a weight average molecular weight of 13000, an acid value of 8 mgKOH/g, and a glass transition temperature of 74° C.)·
Fischer-Tropsch waxes 9.00 parts
   (manufactured by Sasol Ltd., product name “C80”, with a melting point of 83.0° C.)

### (Granulation Process)

The polymerizable monomer composition was added to the container containing the aqueous medium containing (fine particles of) calcium phosphate prepared during the preparation of the aqueous medium containing the dispersion stabilizer, stirred at 8000 rpm for 5 minutes using a T.K. homomixer while the temperature was maintained at 65° C., and subjected to granulation. To the container, 7.50 parts of a polymerization initiator t-butylperoxy pivalate (temperature at which the half-life is 10 hours: 58° C.) was added and stirred for 1 minute.

### (Reaction Process)

Thereafter, the stirred materials were transferred into a reaction tank (separable glass flask with a capacity of 2 L) and subjected to a polymerization process while the materials were stirred at 75 rpm using a paddle stirring blade and the temperature was increased to 70° C. The rate of temperature increase was 0.25° C./min. During the temperature increase, the inside of the reaction tank was checked, and a significant decrease in generated foam was confirmed.

After the temperature increase, the materials were stirred for 4 hours. After the polymerization reaction was completed, a toner particle 1 dispersion liquid was obtained.

After the foregoing operation was performed consecutively 10 times, the mass of the reaction tank expected to have the largest amount of scale adhesion in the particle-forming process in the present example was measured, and the amount of adhesion was calculated from the difference from the mass measured in advance before the production. Further, the temperature T (° C.) of the aqueous medium and Q/V, which is the ratio between the stirrer discharge rate Q (L/min) and the total amount V (L) of the aqueous medium, are presented in Table 1.

The amount of scale adhesion (g) in the reaction tank container during the production of the toner particle 1, the particle size distribution (D4/D1, average value of 10 measurements) of the toner particles obtained after the polymerization reaction was completed, and the amount of coarse particles (average value of 10 measurements) of the toner particles obtained after the polymerization reaction was completed are presented in Table 2.

### Preparation of Toner Particles 2 to 5 and 7 to 13 (Second to Fifth and Seventh to Thirteenth Examples)

Toner particles 2 to 5 and 7 to 13 were obtained by the same method as the toner particle 1, except that the FB deionized water type and reaction tank conditions were changed as specified in Table 1. Table 2 presents the amount of scale adhesion (g) in the reaction tank container during the toner particle production, the particle size distribution (average value of 10 days) of toner particles obtained after the completion of reaction, and the amount of coarse particles (average value of 10 days) of toner particles obtained after the completion of reaction.

### Preparation of Toner Particle 6 (Sixth Example)

### “Synthesis of Polyester Resin 1”

Bisphenol A ethylene oxide 2-mol adduct 8 mol parts
Bisphenol A propylene oxide 2-mol adduct 85 mol parts
Terephthalic acid 45 mol parts
Fumaric acid 28 mol parts
Dodecenyl succinic acid 24 mol parts

The monomers were introduced into a container with a stirrer, a capacitor, a thermometer, and a nitrogen introduction tube, the temperature was increased to 195° C. in 1 hour, and it was confirmed that the reaction system was evenly stirred inside. To 100 parts of the monomers, 1.0 parts of tin distearate was added. Further, while the water generated is distilled off, the temperature was increased from 195° C. to 250° C. over 5 hours, and a dehydration condensation reaction was conducted at 250° C. for 2 hours.

As a result, a polyester resin 1 with a glass transition temperature of 59.3° C., an acid value of 15.3 mgKOH/g, a hydroxyl value of 26.3 mgKOH/g, a weight average molecular weight of 9800, and a number average molecular weight of 3800 was obtained.

### “Synthesis of Polyester Resin 2”

Bisphenol A ethylene oxide 2-mol adduct 42 mol parts
Bisphenol A propylene oxide 2-mol adduct 42 mol parts
Terephthalic acid 69 mol parts.
Dodecenyl succinic acid 30 mol parts

The monomers were introduced into a container with a stirrer, a capacitor, a thermometer, and a nitrogen introduction tube, the temperature was increased to 195° C. in 1 hour, and it was confirmed that the reaction system was evenly stirred inside. To 100 parts of the monomers, 0.7 parts of tin distearate was added. Further, while the water generated is distilled off, the temperature was increased from 195° C. to 240° C. over 5 hours, and a dehydration condensation reaction was conducted at 240° C. for 2 hours. Next, the temperature was decreased to 190° C., 5 mol parts of trimellitic anhydride was gradually added, and the reaction was continued at 190° C. for 1 hour.

As a result, a polyester resin 2 with a glass transition temperature of 55.8° C., an acid value of 13.3 mgKOH/g, a hydroxyl value of 22.1 mgKOH/g, a weight average molecular weight of 41500, and a number average molecular weight of 5700 was obtained.

### “Preparation of Resin Particle Dispersion Liquid 1”

Polyester resin 1 100 parts
Methylethyl ketone 50 parts
Isopropyl alcohol 20 parts

Methylethyl ketone and isopropyl alcohol were added to a container. Thereafter, the resin 1 was added gradually and stirred until it was completely dissolved, and a polyester resin 1 solution was obtained. The container containing the polyester resin 1 solution was set to 65° C., and while it was stirred, a total of 5 parts of 10% aqueous solution of ammonia was gradually dripped, 230 parts of the deionized water 1 containing fine bubbles was gradually dripped at a rate of 10 ml/min, and phase inversion emulsification was caused to occur. Further, solvent removal was performed under reduced pressure using an evaporator, and a resin particle dispersion liquid 1 of the polyester resin 1 was obtained. The volume average particle size of the resin particles was 133 nm. Further, the resin particle solid content was adjusted to 20 mass % using the FB deionized water 1.

### “Preparation of Resin Particle Dispersion Liquid 2”

Polyester resin 2 100 parts
Methylethyl ketone 50 parts
Isopropyl alcohol 20 parts

Methylethyl ketone and isopropyl alcohol were added to a container. Thereafter, the resin 2 was added gradually and stirred until it was completely dissolved, and a polyester resin 2 solution was obtained. The container containing the polyester resin 2 solution was set to 40° C. and while it was stirred, a total of 3.5 parts of 10% aqueous solution of ammonia was gradually dripped, 230 parts of the FB deionized water 1 was gradually dripped at a rate of 10 ml/min, and phase inversion emulsification was caused to occur. Further, solvent removal was performed under reduced pressure, and a resin particle dispersion liquid 2 of the polyester resin 2 was obtained. The volume average particle size of the resin particles was 158 nm. Further, the resin particle solid content was adjusted to 20 mass % using the deionized water 1.

### “Preparation of Colorant Particle Dispersion Liquid”

Copper phthalocyanine (Pigment Blue 15:3) 48 parts
Ionic surfactant NEOGEN RK (manufactured by DKS Co. Ltd.) 5 parts.
FB deionized water 1 190 parts

The foregoing materials were mixed, dispersed for 10 minutes using a homogenizer (ULTRA-TURRAX manufactured by IKA), and thereafter subjected to a dispersion process at a pressure of 250 MPa for 20 minutes using an ultimizer (counter collision type wet grinding machine, manufactured by Sugino Machine Limited), and a colorant particle dispersion liquid was obtained. The volume average particle size of colorant particles of the colorant particle dispersion liquid was 125 nm, and the solid content of the colorant particle dispersion liquid was 20 mass %

### “Preparation of Release Agent Particles Dispersion Liquid”

Release agent (hydrocarbon wax, melting point: 79° C.) 13 parts
Ionic surfactant NEOGEN RK (manufactured by DKS Co. Ltd.) 2 parts
FB deionized water 1 240 parts

The foregoing materials were heated to 100° C., dispersed thoroughly using an ULTRA-TURRAX T50 manufactured by IKA, and thereafter heated to 115° C. and subjected to a dispersion process for 1 hour using a pressure-discharge-type Gaulin homogenizer, and a release agent particle dispersion liquid with a volume average particle size of 155 nm and a solid content of 20 mass % was obtained.

### “Preparation of Toner Particle 6 (Emulsion Aggregation)”

Resin particle dispersion liquid 1 500 parts
Resin particle dispersion liquid 2 400 parts
Colorant particle dispersion liquid 50 parts
Release agent particle dispersion liquid 80 parts

First, as a core forming process, the foregoing materials were added to a reaction tank (separable glass flask with a capacity of 2 L) and mixed. Next, the mixture was dispersed at 5000 r/min for 10 minutes using a homogenizer ULTRA-TURRAX T50 (manufactured by IKA). After 1.0% aqueous solution of nitric acid was added and the pH was adjusted to 3.0, the mixed solution was heated to 65° C. while the number of rotations was controlled to 3000 r/min to stir the mixed solution in a heating water bus using a stirring blade.

The reaction tank was checked after the materials were added to the tank, and foam generation was confirmed. Furthermore, as the reaction tank was heated, a significant decrease in generated foam was confirmed. The volume average particle size of formed aggregation particles was checked periodically, and when 4.3-μm aggregation particles (cores) were formed, the following materials were added and stirred for 1 hour to form shells, as a shell forming process.
FB deionized water 1 300 parts
Resin particle dispersion liquid 1 40 parts

Thereafter, the pH was adjusted to 9.0 using 5% aqueous solution of sodium hydroxide, and while stirring was continued, heating was conducted to 70° C. When desired surface profiles were obtained, heating was stopped, and a toner-particle dispersion liquid was obtained.

After the foregoing operation was performed consecutively 10 times, the mass of the reaction tank expected to have the largest amount of adhesion in the particle-forming process in the present example was measured, and the amount of adhesion was calculated from the difference from the mass measured in advance before the production. Further, the temperature T (° C.) of the aqueous medium and Q/V, which is the ratio between the stirrer discharge rate Q (L/min) and the total amount V (L) of the aqueous medium, are presented in Table 1.

The amount of scale adhesion (g) in the reaction tank container during the production of the toner particles 6, the particle size distribution (average value of 10 measurements) of the toner particles obtained after the reaction was completed, and the amount of coarse particles (average value of 10 measurements) of the toner particles obtained after the reaction was completed are presented in Table 2.

### Preparation of Comparative Toner Particles 1 to 3 (First to Third Comparative Examples)

Comparative toner particles 1 to 3 were obtained by a similar method as the toner particle 1, except that the FB deionized water type and reaction tank conditions were changed as specified in Table 1. The deionized water prepared in the example of the production of FB deionized water was used directly as “deionized water” for the toner particle 3.

After the materials were transferred into a reaction tank and the temperature increase was completed, foam in the reaction tank was visually checked, and a significant increase in generated foam was confirmed. The amount of scale adhesion, the particle size distribution, and the amount of coarse particles during the production of the comparative toner particles are presented in Table 2.

### Preparation of Comparative Toner Particle 4 (Fourth Comparative Example)

A comparative toner particle 4 was obtained by a similar method as the toner particle 6, except that the deionized water type and reaction tank conditions were changed as specified in Table 1. The deionized water prepared in the example of the production of deionized water containing fine bubbles was used directly as “deionized water” for the comparative toner particle 4.

After the materials were transferred into a reaction tank and the temperature increase was completed, foam in the reaction tank was visually checked, and a significant increase in generated foam was confirmed. The amount of scale adhesion, the particle size distribution, and the amount of coarse particles during the production of the comparative toner particle 4 are presented in Table 2.

### Evaluations

Evaluations were conducted based on the obtained values in Table 2, and the evaluation results were added to Table 2. Evaluation criteria are as follows.

### <Evaluation Criteria for Amount of Adhesion>

A: less than or equal to 3.0 g
B: greater than 3.0 g, less than or equal to 10.0 g
C: greater than 10.0 g, less than or equal to 15.0 g
D: greater than 15.0 g, less than or equal to 20.0 g
E: greater than 20.0 g

In the present disclosure, it is determined that a rating of C or higher is considered acceptable.

### <Evaluation Criteria for Particle Size Distribution>

A: less than or equal to 1.15
B: greater than 1.15, less than or equal to 1.25
C: greater than 1.25, less than or equal to 1.35
D: greater than 1.35

In the present disclosure, it is determined that a rating of C or higher is considered acceptable.

### <Evaluation Criteria for Coarse Particle Content>

A: less than or equal to 1.0 g
B: greater than 1.0 g, less than or equal to 5.0 g
C: greater than 5.0 g, less than or equal to 10.0 g
D: greater than 10.0 g

In the present disclosure, it is determined that a rating of C or higher is considered acceptable.

TABLE 1

| | | | | | | | | | Temperature | |
|---|---|---|---|---|---|---|---|---|---|---|
| | | Deionized Water Containing Fine Bubbles | | | | | | | Increase Rate | |
| | | | | Number | | | | | (° C./min) | |
| | | | Number | Average | | | | | after | |
| | Toner | | Concentration | Particle | | Temperature | | 500 × | Addition of | |
| | Particle | | A | Size B | | T | | Q/V + | Polymerization | Manufacturing |
| | No. | Type | (bubbles/mL) | (nm) | A/B | (° C.) | Q/V | 30 | Initiator | Method |
| First | 1 | FB | 1.70 × 10⁶ | 1.5 × 10² | 1.1 × 10⁴ | 70 | 0.113 | 86.5 | 0.25 | Suspension |
| Example | | Deionized | | | | | | | | Polymerization |
| | | Water 1 | | | | | | | | |
| Second | 2 | FB | 1.68 × 10⁶ | 5.5 × 10¹ | 3.1 × 10⁴ | 70 | 0.113 | 86.5 | 0.25 | Suspension |
| Example | | Deionized | | | | | | | | Polymerization |
| | | Water 2 | | | | | | | | |
| Third | 3 | FB | 1.48 × 10⁶ | 9.1 × 10² | 1.6 × 10⁴ | 70 | 0.113 | 86.5 | 0.25 | Suspension |
| Example | | Deionized | | | | | | | | Polymerization |
| | | Water 3 | | | | | | | | |
| Fourth | 4 | FB | 1.18 × 10⁵ | 8.5 × 10³ | 1.4 × 10¹ | 70 | 0.113 | 86.5 | 0.25 | Suspension |
| Example | | Deionized | | | | | | | | Polymerization |
| | | Water 4 | | | | | | | | |
| Fifth | 5 | FB | 1.29 × 10⁵ | 9.2 × 10⁴ | 1.4 × 10⁰ | 70 | 0.113 | 86.5 | 0.25 | Suspension |
| Example | | Deionized | | | | | | | | Polymerization |
| | | Water 5 | | | | | | | | |
| Sixth | 6 | FB | 1.70 × 10⁶ | 1.5 × 10² | 1.1 × 10⁴ | 70 | 0.113 | 86.5 | — | Emulsion |
| Example | | Deionized | | | | | | | | Aggregation |
| | | Water 1 | | | | | | | | |
| Seventh | 7 | FB | 1.70 × 10⁶ | 1.5 × 10² | 1.1 × 10⁴ | 70 | 0.085 | 72.5 | 0.25 | Suspension |
| Example | | Deionized | | | | | | | | Polymerization |
| | | Water 1 | | | | | | | | |
| Eighth | 8 | FB | 1.70 × 10⁶ | 1.5 × 10² | 1.1 × 10⁴ | 65 | 0.075 | 67.5 | 0.25 | Suspension |
| Example | | Deionized | | | | | | | | Polymerization |
| | | Water 1 | | | | | | | | |
| Ninth | 9 | FB | 1.70 × 10⁶ | 1.5 × 10² | 1.1 × 10⁴ | 70 | 0.075 | 67.5 | 0.25 | Suspension |
| Example | | Deionized | | | | | | | | Polymerization |
| | | Water 1 | | | | | | | | |
| Tenth | 10 | FB | 1.70 × 10⁶ | 1.5 × 10² | 1.1 × 10⁴ | 80 | 0.075 | 67.5 | 0.25 | Suspension |
| Example | | Deionized | | | | | | | | Polymerization |
| | | Water 1 | | | | | | | | |
| Eleventh | 11 | FB | 1.70 × 10⁶ | 1.5 × 10² | 1.1 × 10⁴ | 70 | 0.113 | 86.5 | 0.35 | Suspension |
| Example | | Deionized | | | | | | | | Polymerization |
| | | Water 1 | | | | | | | | |
| Twelfth | 12 | FB | 1.13 × 10⁵ | 1.5 × 10² | 7.6 × 10² | 70 | 0.113 | 86.5 | 0.35 | Suspension |
| Example | | Deionized | | | | | | | | Polymerization |
| | | Water 6 | | | | | | | | |
| Thirteenth | 13 | FB | 1.13 × 10⁵ | 1.5 × 10² | 7.6 × 10² | 70 | 0.075 | 67.5 | 0.35 | Suspension |
| Example | | Deionized | | | | | | | | Polymerization |
| | | Water 6 | | | | | | | | |
| First | Comparative | FB | 1.29 × 10⁵ | 1.6 × 10⁵ | 0.8 × 10⁰ | 70 | 0.075 | 67.5 | 0.35 | Suspension |
| Comparative | Toner | Deionized | | | | | | | | Polymerization |
| Example | Particle 1 | Water 7 | | | | | | | | |
| Second | Comparative | FB | 5.67 × 10⁴ | 1.5 × 10² | 3.8 × 10² | 70 | 0.075 | 67.5 | 0.35 | Suspension |
| Comparative | Toner | Deionized | | | | | | | | Polymerization |
| Example | Particle 2 | Water 8 | | | | | | | | |
| Third | Comparative | Deionized | — | — | — | 70 | 0.075 | 67.5 | 0.35 | Suspension |
| Comparative | Toner | Water | | | | | | | | Polymerization |
| Example | Particle 3 | | | | | | | | | |
| Fourth | Comparative | Deionized | — | — | — | 70 | 0.075 | 67.5 | — | Emulsion |
| Comparative | Toner | Water | | | | | | | | Aggregation |
| Example | Particle 4 | | | | | | | | | |

TABLE 2

| | | | | | | Amount of |
|---|---|---|---|---|---|---|
| | | Amount of | | Particle Size | Amount | Coarse |
| | Amount of | Adhesion | | Distribution | of Coarse | Particles |
| | Adhesion | Evaluation | Particle Size | Evaluation | Particles | Evaluation |
| | (g) | Result | Distribution | Result | (g) | Result |
| First | 2.1 | A | 1.12 | A | 0.4 | A |
| Example | | | | | | |
| Second | 1.1 | A | 1.14 | A | 0.3 | A |
| Example | | | | | | |
| Third | 2.6 | A | 1.14 | A | 0.6 | A |
| Example | | | | | | |
| Fourth | 5.8 | B | 1.13 | A | 0.8 | A |
| Example | | | | | | |
| Fifth | 12.6 | C | 1.13 | A | 0.7 | A |
| Example | | | | | | |
| Sixth | 2.3 | A | 1.13 | A | 0.7 | A |
| Example | | | | | | |
| Seventh | 2.4 | A | 1.18 | B | 0.6 | A |
| Example | | | | | | |
| Eighth | 1.8 | A | 1.21 | B | 0.6 | A |
| Example | | | | | | |
| Ninth | 2.6 | A | 1.27 | C | 0.9 | A |
| Example | | | | | | |
| Tenth | 7.6 | B | 1.29 | C | 0.5 | A |
| Example | | | | | | |
| Eleventh | 2.5 | A | 1.13 | A | 2.6 | B |
| Example | | | | | | |
| Twelfth | 1.9 | A | 1.14 | A | 6.8 | C |
| Example | | | | | | |
| Thirteenth | 2.3 | A | 1.28 | C | 7.5 | C |
| Example | | | | | | |
| First | 18.2 | D | 1.32 | C | 10.8 | D |
| Comparative | | | | | | |
| Example | | | | | | |
| Second | 17.6 | D | 1.33 | C | 9.5 | C |
| Comparative | | | | | | |
| Example | | | | | | |
| Third | 25.6 | E | 1.46 | D | 17.5 | D |
| Comparative | | | | | | |
| Example | | | | | | |
| Fourth | 22.5 | E | 1.42 | D | 16.3 | D |
| Comparative | | | | | | |
| Example | | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-021720, filed Feb. 16, 2024, which is hereby incorporated by reference herein in its entirety.

What is claimed is:

1. A toner manufacturing method comprising:
a particle-forming process including forming a resin particle while foam is generated in an aqueous medium,
wherein the aqueous medium contains a fine bubble, and
wherein the fine bubble has a number average particle size greater than or equal to 1.0×10¹ nm and less than or equal to 1.0×10⁵ nm and has a number concentration greater than or equal to 1.00×10⁵ bubbles/mL.

2. The toner manufacturing method according to claim 1, wherein the particle-forming process comprises forming a resin particle by polymerizing a polymerizable monomer in a droplet particle dispersed in the aqueous medium using a polymerization initiator, and the foam generated is caused by gas produced as a result of cleavage of the polymerization initiator.

3. The toner manufacturing method according to claim 1, wherein the particle-forming process is performed while the aqueous medium is stirred, and the foam generated is produced as stirring is performed.

4. The toner manufacturing method according to claim 1, wherein inequality (1) is satisfied:
T<500×Q/V+30 inequality (1),
where Q (L/min) represents a discharge rate of a stirrer in the particle-forming process, V (L) represents a total amount of the aqueous medium, and T (° C.) represents a temperature of the aqueous medium.

5. The toner manufacturing method according to claim 1, wherein inequality (2) is satisfied:
A/B>1.0×10³ inequality (2),
where A represents the number concentration (bubbles/mL) of the fine bubble, and B represents the number average particle size (nm) of the fine bubble.

6. The toner manufacturing method according to claim 1,
wherein the particle-forming process comprises forming a resin particle by polymerizing a polymerizable monomer in a droplet particle dispersed in the aqueous medium using a polymerization initiator and includes increasing a temperature after the polymerization initiator is added, and the temperature is increased at a rate of 0.3° C./min or less in the process of increasing the temperature.
